(19) United States
(12) Patent Application Publication
(10) Pub. No.: US 2013/0102695 A1
(43) Pub. Date: Apr. 25, 2013

(54) POLY(LACTIC ACID) AND POLYOLEFIN FILMS CONTAINING POROSITY AND SORBENTS

(71) Applicant: Chieh-Chun Chau, Victor, NY (US)

(72) Inventor: Chieh-Chun Chau, Victor, NY (US)

(21) Appl. No.: 13/276,953

(22) Filed: Oct. 19, 2011

(51) Int. Cl. C08J 9/00; B29C 67/20

(52) U.S. Cl. 521/134; 264/210.1

(57) ABSTRACT

Single and multilayer porous polyolefin films are prepared by extruding polyolefin with poly(lactic acid) (PLA) and followed by uniaxial or biaxial stretching. PLA is used as a pore former that creates porosity. The film provides adjustable gas and water vapor transmission rate by varying the PLA content. Sorbents may optionally be added in the formulation in selective layers. The porous films are useful in packaging and consumable applications. In particular, partially miscible blends of PP and PLA is useful for creating fine porosity due to the fine PLA domains in the miscible blends.

### FIELD OF THE INVENTION

This invention relates to a sheet having at least one porous layer comprising polyolefin and biodegradable resin and an oxygen absorber. In a preferred form the invention relates to a sheet that is a combination of a porous layer of polyolefin and lactic acid resin and at least one nonporous layer of polyolefin and oxygen absorber.

### BACKGROUND OF THE INVENTION

Use of polymer films in the packaging of food, medicine and other products is well known.

Among conventional films utilizing in packaging are porous films formed by utilization of calcium carbonate and talc in a polyolefin or other polymer that is extruded and then subjected to unidirectional or bidirectional stretching. Such films appear white or silvery as the voids around the talc or calcium carbonate affected transmission of light through the film. There are many such commercial products utilized in wrappers for candy bars and in bags for salty snacks like potato chips. Medicines are also packaged in polymer packages that control the transmission of water vapor and oxygen through the package in order to maintain the effective life of the medicine during storage.

It is also known that the polymer resin packaging materials are difficult to recycle and there is a continuing interest in packaging materials that are easier to recycle or biodegradable.

In US Patent Publication No. 2009/0326130-Li it is disclosed that a film comprising polylactic acid and polypropylene polymer may be formed. The utilization of pore performers is also discussed therein as is the utilization of the blended polylactic acid (PLA) and polypropylene sheets for packaging foods.

U.S. Pat. No. 6,824,864-Bader discloses a composite three layer structure. The structure may have cavities in the core layer and have a high water vapor transmission rate.

There remains a need for packaging sheet material that is safe for use in packaging, provides a controlled passage of gaseous materials and provides for the absorption of oxygen.

### PROBLEM TO BE SOLVED BY THE INVENTION

There is a need for a biodegradable packaging material with oxygen absorption properties and controlled gas permeability.

### BRIEF SUMMARY OF THE INVENTION

It is an object of this invention to provide improved packaging materials.

It is another object of the invention to provide control of gaseous permeability of packaging materials.

These and other objects of the invention generally are accomplished by a sheet comprising at least one porous layer comprising a blend of polyolefin and biodegradable resin and an oxygen absorber or water vapor absorber.

### BRIEF DESCRIPTION OF THE DRAWING

FIG. 1 is a schematic drawing showing the continuous MDO film stretching processes.

### DETAILED DESCRIPTION OF THE INVENTION

This invention has numerous advantages over prior products. The invention allows formation of a biodegradable material with the ability to control the permeation of gas through the material by controlling porosity during the formation of the packaging sheets. The invention utilizes biodegradable polymer as the pore former as well as the polymer that allows the easily biodegradable sheet to be formed. The material allows improved oxygen scavenging and/or water vapor scavenging to protect a packaged material from degradation.

Single and multilayer porous polyolefin films are prepared by extruding polyolefin with poly(lactic acid) (PLA) and followed by uniaxial or biaxial stretching. PLA is used as a pore former that creates porosity. The film provides adjustable gas and water vapor transmission rate by varying the PLA content. Generally the more porous the film the greater the permeability. The size of the pores is generally controlled by the amount of orientation, with larger pores often forming a thinner more permeable layer or sheet. The number of pores is controlled by the amount of dispersed pore former present. Sorbents may optionally be added in the formulation in other layers of the packaging material of the invention. The porous films are useful in packaging and consumable applications. In particular, partially miscible blends of PP and PLA is useful for creating fine porosity due to the fine PLA domains in the miscible blends.

Disclosed in this invention is a method of making single and multilayer films that consist of PLA and polyolefin resins. At least certain layers of the films contain porosity that will facilitate gas and vapor transport. The porosity is induced by the PLA composition blended in the film in which PLA serves as a pore former and develops pores upon stretching. The films contain sorbent such as oxygen scavenger, silica gel, molecular sieve or activated carbon dispersed in a layer of the film.

In one of the embodiments, film is extruded in single or multilayer polymer films containing PLA and a polyolefin resin such as polypropylene or polyethylene. For single layer film, the PLA and polyolefin and a sorbent can be extruded into film and wound on a spool. A preferred structure is a three layer coextruded film with PLA and polyolefin blends in the two exterior layers and a polyolefin-only resin with sorbent in the middle layer, as in Table I, because this structure allows control of passage of oxygen and water vapor and does not allow food to contact the oxygen absorber layer. The non-porous polyolefin layer contains a sorbent material as particles and dispersed in the non-porous polyolefin layer. A layer diagram of the structure is shown in Table 1 as a three-layer structure that consists of layers that have PLA and polyolefin and the middle non-porous layer that consists of polyolefin and oxygen scavenger. Typically the three layer films would have a thickness of between 25 microns and 250 microns.

TABLE 1
PLA + Polyolefin
Polyolefin only with Oxygen Absorber
PLA + Polyolefin

Other oriented layer structures of this invention includes:

TABLE 2
Porous − PLA and Polyethylene
Polyethylene and Oxygen Absorber

TABLE 3
Oxygen Barrier Polymer such as Polyvinyl Alcohol
Polyethylene and Oxygen Absorber
Polypropylene + PLA − Porous

TABLE 4
Porous PLA + Polyethylene
Polyethylene plus Ion O₂ Scavenger + Activated Carbon
PLA + Polypropylene − Porous

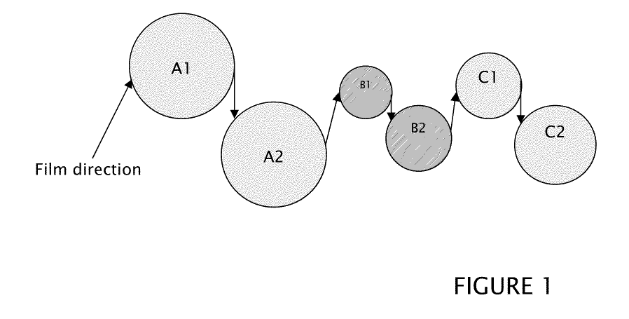

Uniaxial or biaxial stretching of FIG. 1 is carried out to stretch the films to a desired strain to create porosity or voids in the PLA-containing layers. For uniaxial stretching the process can be done on a conventional machine direction orientation (MDO) machine. A drawing of an MDO is shown in FIG. 1 in which the film is passing through a series of rolls with stretching taking place between two stretch rolls B1 and B2. The rolls A1, A2 and C1, C2 are serving as stabilizing rolls that allows stable and continuous transport of the film. A simple static stretching device such as Instron tensile stretcher can be used for batch operation to make samples for test.

For biaxial stretching, the film can be stretched by using a biaxial stretcher such as the commercially available Brucker MDO/TDO stretcher. Or the film can be stretched sequentially along the machine direction (MD) then the transverse direction (TD) by static or continuous known processes. All the stretching is preferably conducted at ambient temperature such as 20° C. to 30° C. range.

Both the uniaxial and biaxial stretching process can be adjusted such that stress-whitening pore forming behavior can be induced. Stress-whitening is a common sign of porosity or cavitation in which voids or pores are developed through the stretching deformation. These voids or pores are not usually penetrating through the thickness of the film, rather, they developed as isolated domains. Controlling the size and number of the pores controls oxygen and water vapor permeability. These porous domains help gas and vapor transport to result in higher transport rate.

The stretched films can be wound on a spool ready for next step uses, such as lamination to other films, or formation of packages, or use as a wrap.

In a preferred form, the invention relates to the use of miscible or partially miscible blends of PLA with polypropylene (PP). PLA and PP were found to be miscible or partially miscible by melt extrusion. The miscibility is detected by the shifting of the melting point and/or forming of new melting and/or crystallization temperatures of the PP in the blends with PLA through thermal analysis. By using PLA and PP blends, the stretched or stress-whitened porous film contains finer or more uniform pores or voids due to the fine PLA domains developed in the blends. Miscible or partially miscible blends are desirable for blending to extrude or mold a product because the blends can form a single phase structure and that leads to the improvement of the physical properties over non-miscible blends. The layers containing the iron based oxygen absorber are substantially pore free as the iron particles of size 1 to 25 micron are not pore forming.

This invention relates to the use of the porous films for food bags and packaging. The applications include laminating the porous films that contain oxygen scavenger onto a substrate such as polyethyleneterapholate (PET) or a composite film that contains PET by using conventional adhesive laminating method. The invention also includes converting the laminated film or sheet into bags, pouches, or containers by using conventional vertical form fill seal (VFFS), horizontal form fill seal (HFFS) or thermoforming process methodologies. The bags and pouches produced from this invention can provide a higher gas and water vapor transmission rates desirable for refrigeration condition.

The invention generally uses PLA as a pore former upon mechanical stretching. When PLA is blended with a polyolefin resin, the PLA resin, due to its brittleness and more amorphous nature, can be cavitated upon deformation. This behavior allows PLA to be used as a pore former to do the job like CaCO₃, talc, Mg(OH)₂ and other inorganic minerals that are commonly used for making porous films by cavitation. PLA can be totally amorphous or contain some degree of crystallinity. The D-lactide in the PLA is preferably 1% or higher, more preferably 3% or higher for good pore forming. The typical PLA resins are NatureWorks' Ingeo PLA 2002D, 2003D and 4032D grades. The PLA content can range from 5-95% balanced by polyolefin resins, preferably 20-90%, more preferably 30-80% for strong sheets with good porosity. In the invention products the pores are generally closed.

The polymers useful for making the oxygen scavenging articles can include common polyolefins such as polypropylene (PP), low density polyethylene (LDPE), high density polyethylene (HDPE), and their derivatives or copolymers. In particular interest is PP which is found to be at least partially miscible with PLA as evidenced by a new crystallization temperature revealed from differential scanning calorimetry. A miscible or partially miscible blend can give more homogeneous properties, and finer pores upon subsequent stretching process.

Optionally elastomers such as ethylene-propylene copolymers, styrene-butadiene-styrene, styrene-ethylene-butylene-styrene, styrene-isoprene-styrene, and other elastomeric polymers can be added in the blends of PLA and polyolefin to adjust the physical properties.

Any suitable oxygen absorber may be utilized. Preferred for effective absorption and low cost is reduced iron powder preferably having 1-200 μm mean particle size, more preferably 1-25 μm mean and most preferably 1-10 μm mean, as the 1-25 μm particles are not pore forming to a significant degree. The iron can be mixed with salt or a combination of different electrolytic and acidifying components. The iron particles can also be coated with salt. The combination and relative fraction of activating electrolytic and acidifying components coated onto the iron particles can be selected according to the teachings of U.S. Pat. No. 6,899,822-McKedy and U.S. Patent Publication No. 2005/020584-Chan et al., incorporated herein by reference. The coating technique is preferably a dry coating process as described in the references above. The loading of the iron-based oxygen scavenger can be ranging from 1-30%, preferably 2-15%, depending on the application and temperature. If the use is in the refrigerated condition, the content will be higher.

Any suitable salt can be used with the iron. The salt can be any inorganic salt such as sodium, potassium or calcium based ionic compounds that are soluble in water. Typical examples include NaCl, KCl, NaHSO4, Na₂HPO₄ and others. A mixture of separate electrolytic and acidifying salt components can be advantageously used in the formulation as described in prior art. Sodium chloride is preferred as it is effective and low in cost.

Other sorbents include silica gel, activated carbon, molecular sieve and other sorbent materials, a mixture of the materials such as activated carbon/silica gel=50/50 mixture can be used. The total loading can range from 2-80 wt %, preferably 5-60%, more preferably 10-50%. These other sorbent materials absorb water and odors.

The oxygen scavenging fabricated articles can be films or sheets, single or multilayer, that are porous or solid, and consisting of iron-based oxygen scavengers and electrolytes such as in US Patent Publication No. 2010/0244231 to Chau et al., and consisting of moisture regulators with a chosen water activity. The films or sheets can be laminated, thermoformed, or die-cut by conventional die cutting tool and dispensed like lidding materials. They can also be die cut inline to fit a specific packaging process.

The extruded film or sheet can be uniaxially stretched using conventional MDO tools. It can also be biaxially stretched by MDO/TDO tools to create voids or pores through deformation of pore formers. The draw ratio, defined as the ratio of the stretch length divided by the original length, can range from 1.1 to 1000, or in a range suitable to create porosity in the breathable film preparation art. Static stretching tools such as Instron tensile stretcher can also be used to create porosity.

Other biodegradable polymers may be utilized in the invention and can include all common polymers generated from renewable resources and biodegradable polymers such as starch based polymers thermoplastics starch, PHA, PHB. Biodegradable polymers that are petroleum based such as polyethylene oxide, PVOH may also be included as a blend composition. But these blend compositions do not replace PLA as the main blend composition with polyolefins to work as a pore former.

The following example is used to illustrate some parts of the invention:

### Example 1

### Preparation of Oxygen Scavenging Films Containing Porosity

Resins used in this example are PLA of NatureWorks 2003D resin (PLA), polypropylene of Flint Hills AP6120 impact copolymer, and Kraton 1657 styrene-ethylene/butylene-styrene (SEBS). These resins are blended with a ratio of PLA/PP/Kraton=45/45/10. Freshblend oxygen scavenger of self-coated on iron and sodium bisulfate and NaCl comprising by weight about 3% sodium chloride, about 12% sodium bisulfate and 85% iron in fine powder format is used as 1% additive in the blend to demonstrate that active ingredient can be included in the formulation without affecting the porous film formation as described below.

Using the above resin composition, films approximately 4.5 mil thick and 4″ in width, are extruded from a lab scale extruder at 220° C. extruder barrel and die temperature. The extruded films are uniform, translucent and collected on a roll. Samples of 2.5″ wider are cut from the roll and tensile stretched in an Instron tensile stretcher along the machine direction. The samples with a gauge length of 4″ are stretched to 150% elongation (or a draw ratio of 2.5) at room temperature. The films appeared to be white and opaque. The stress-whitening behavior indicates porosity.

To test the gas transport properties of the films, both the unstretched and stress-whitened (stretched) films are tested for their oxygen permeation rate by using an Illinois Instrument oxygen permeation measurement device at room temperature and 50% RH condition. The oxygen permeation rate is then used for permeability calculation. The results showed that the stress-whitened film has an oxygen permeability of 775 cc-mil/(100 in²-day-atm), while the unstretched control have an oxygen permeability of 190 cc-mil/(100 in²-day-atm). The stress-whitened film have approximately 4.1 times higher permeability than the unstretched control.

1. A sheet comprising at least one porous layer comprising a blend of polyolefin and biodegradable resin and an oxygen absorber or water absorber.

2. The sheet of claim 1, wherein the polyolefin of the porous layer comprises polypropylene.

3. The sheet of claim 1 further comprising at least one substantially nonporous polyolefin resin layer.

4. The sheet of claim 3, wherein oxygen absorber is present in the substantially nonporous polyolefin resin.

5. The sheet of claim 4 further comprising at least one porous layer of a blend of polyolefin and polylactic acid resin on each side of the substantially non-porous polyolefin resin layer.

6. The sheet of claim 1, wherein the blend of polyolefin to polylactic acid resin is in a weight ratio of between 5 to 95 and 95 to 5.

7. The sheet of claim 4, wherein the at least one porous layer comprises between 2 and 90% pores by volume.

8. The sheet of claim 4, wherein the at least one porous layer will pass oxygen at a permeability of between 10 and 10,000 cc-mil/(100 in²-day-atm).

9. The sheet of claim 1 wherein the biodegradable polymer comprises polylactic acid.

10. A method of forming oxygen scavenging sheet comprising:
extruding at least one layer comprising polyolefin resin blended with a biodegradable polymer resin and at least one layer comprising a substantially nonporous polyolefin resin and an oxygen scavenger, stretching the coextruded oxygen scavenging sheet to form pores in the at least one layer comprising polyolefin resin blended with polylactic acid resin.

11. The method of claim 10, wherein the polyolefin of the porous layer comprises polypropylene.

12. The method of claim 10 wherein the biodegradable resin polymer comprises polylactic acid.

13. The method of claim 10, wherein the at least one substantially nonporous polyolefin resin layer comprises polyethylene.

14. The method of claim 10, wherein oxygen absorber comprises iron.

15. The method of claim 10 further comprising at least one porous layer of a blend of polyolefin and polylactic acid resin on each side of the substantially non-porous polyolefin resin layer.

16. The method of claim 10, wherein the blend of polyolefin to polylactic acid resin is in a weight ratio of between 5 to 95 and 95 to 5.

17. The sheet of claim 10, wherein when the at least one porous layer comprises between 2 and 90 percent pores by volume.
